(19) United States
(12) Patent Application Publication
(10) Pub. No.: US 2005/0230863 A1
(43) Pub. Date: Oct. 20, 2005

(54) Vacuum molding of fibrous structures

(76) Inventors: Mike Scott, Columbia City, IN (US); Ervin Geiger JR., Columbia City, IN (US); Neal Baitcher, Fort Wayne, IN (US)

Correspondence Address: RANDALL J. KNUTH P.C., 4921 DESOTO DRIVE, FORT WAYNE, IN, 46815, US

(21) Appl. No.: 10/987,746

(22) Filed: Nov. 12, 2004

Related U.S. Application Data
(60) Provisional application No. 60/519,600, filed on Nov. 12, 2003.

(51) Int. Cl. B29C 67/08

(52) U.S. Cl. 264/87; 264/169; 425/464

(57) ABSTRACT

A molding tool is especially adapted for vacuum molding or forming of structures and, in particular, fibrous composite structures. Such a molding tool includes a mold plate with narrow slots in the mold surface thereof and wider channels in the back surface thereof, with such slots and channels intersecting one another. The slots and channels are arranged so as to promote an effective, uniform distribution of a vacuum on the mold surface of the mold plate yet not promote deformation and/or dimpling of a part being formed upon the mold surface. A skirt is advantageously provided on the mold plate to facilitate the deposition of the structure material from a suspension during the vacuum molding procedure.

### CROSS-REFERENCE TO RELATED APPLICATIONS

This application claims the benefit of prior filed U.S. Provisional Application No. 60/519,600 entitled filed Nov. 12, 2003, in the name of the above named inventors, the disclosure of which is incorporated herein by reference thereto.

### BACKGROUND OF THE INVENTION

1. Field of the Invention

The present invention relates to vacuum molding of fibrous structures, and, more particularly to an apparatus and method of forming such structures from fibers held initially in suspension in a liquid.

2. Description of the Related Art

In the past fibrous or particulate composite structures have been made, for example, by lay-ups of fibrous woven mats such as made by fibrous carbon or glass. Such lay-ups of these woven mats utilized resin and other binders there between, to form integrated structures formed from such combined mats formed in a mold.

Such structures suffer from the limitations of the woven mats disposed within the mold, namely that based on the shape of the mold, the mats may not follow the contours of the mold as precisely as necessary.

Further, use of the woven mats of fibers, though giving the structure its strength, may have only specific orientations within the structure. What is needed in the art is a way be released from the constraints of the woven mat orientation and have the ability place the fibers in the structure in whatever orientation is necessary.

Whether described as molding or casting, the need for precisely shaped structures or parts may be formed from fibers or particulates arraigned together and bound in some fashion. The present invention improves on past apparatus and methods for forming such structures.

### SUMMARY OF THE INVENTION

The present invention includes a molding tool and method especially adapted for vacuum molding or forming of structures and, in particular, fibrous or particulate composite structures. Such a molding tool includes a mold plate with narrow vent/drain slots in the mold surface thereof and wider channels in the back surface thereof, with such slots and channels intersecting one another. The vent/drain slots and channels are arranged so as to promote an effective, uniform distribution of a vacuum on the mold surface of the mold plate yet not promote deformation and/or dimpling of a part being is formed upon the mold surface.

The present invention, in one form thereof, comprises a molding plate for use in a molding tool for forming a part. This molding plate includes a mold surface and a back surface. The mold surface has a shaped portion corresponding to a desired shape for the part to be formed therewith. The mold surface has a plurality of vent slots formed therein. Further, each vent slot has a corresponding slot width. The back surface is opposite the mold surface and has a plurality of channels formed therein. The channels are formed deep enough in the molding plate so as to fluidly interconnect with at least a set of the vent slots. The channels are substantially co-parallel and each have a channel width. This channel width is much greater than the slot width.

The present invention in another form thereof, includes the method of vacuum forming a fibrous and or particulate based structure of first providing a liquid with suspended such utilized fibers or particulates in suspension within the liquid. Then via vacuum or pressure, passing the liquid suspension through a mold or tool such that the fibers or particulates collect together to essentially form the structure. In one form of the invention a filter or mesh may be utilized to assist in initial formation of the collection of the fibers and or particulates within the tool.

One set of advantages of the present invention relates to inclusion of relatively narrow vent slots in the mold surface in the mold plate of the molding tool and the interconnection of such slots with relatively wider channels formed in the back surface of such a mold plate. The narrow vent slots do not promote deformation and/or dimpling of the surface of the part being formed. Furthermore, the interconnection of the narrow vent slots and wider channels tend to advance the fluid-flow efficiency from the mold surface to the back surface of the mold plate through a potential venturi effect.

Another advantage of the present invention is that the co-parallel layout of the channels helps further the uniformity in fluid flow through the mold plate.

Yet another advantage of the present invention is that having the vent slots in the mold surface be substantially orthogonal to the channels of the back surface promotes an even or average vacuum being applied on each vent slot. Specifically, the potential effect of variances in vacuum over the range of channels are effectively averaged out over the range of vent slots due to the interconnection of each channel with many of the slots.

An even further advantage of the present invention is that the vacuum structure used in relation to the molding tool provides a base that is structured to uniformly distribute a vacuum and also provides a vacuum source that is adjustable to accommodate the potential variety of molding parameters that may exist. Further, based on the geometry of the structure to be formed, the vacuum or pressure experienced by portions of the structure to be formed may be controlled. There is to be no perceived limitation on the applied vacuum or pressure, in that the applied vacuum or pressure to the structure need not be equal across the surface of the structure to be formed.

An additional advantage of the present invention is that the skirt or filter of one form of the present invention is composed of a mat of fibers, the fibers having a size and distribution such that the material being cast and/or molded will deposit thereupon and not flow through the fibrous mat, yet allowing the suspension fluid to be drawn therethrough during the vacuum forming process. By employing such a skirt as part of the casting or molding procedure, it becomes possible to cast or mold as fine (e.g., on the order of microns) as desired as long as the fibers or particulates can be captured by the skirt or filter.

Yet an additional advantage of the present invention is that a potentially multi-functional cure plate is provided to aid in the processing of the preform or cast part being created using the apparatus of the present invention. The cure plate can be self-heating to aid in a curing or drying process. Alternatively or additionally, the cure plate can aid in the finish characteristics; final thickness achieved; overall part shape; and/or part density (especially if used as a press mechanism).

A further advantage of the present invention is that the shapes and/surface features of each of the mold plate, cure plate, and/or skirt or filter may be chosen so as to achieve any of a variety of desired product shapes, including potentially complex shapes and/or fine product details. Use of the skirt to produce such features is further advantageous in that can prove easier/less expensive to change than the main tooling (i.e., the plates).

Yet another advantage of the present invention is that the invention can be used in conjunction with a pulp molding/die-dried process. One such procedure can be felting or molding a blank from a fibrous suspension using the mold tool of the present invention. Another such procedure is drying and/or pressing of a blank using the mold tool and cure plate of the present invention.

An even further advantage of the present invention is that the vacuum molding system can be used in the molding of castable material, both in creating a fibrous skirt/filter from the suspension upon which a cast or molded part may be initially formed, as well as the process of actually casting or molding the part from a suspension of particulate and/or fibrous material to thereby form a cake casting or molding.

Yet an additional advantage of the present invention is that various needs are available to control the tightness of packing of fibrous/particulate material and/or the fiber orientation within either of a cake or a filter/skirt. Such means of manipulation may include, for example, controlling the size distribution and/or composition of the fibers themselves. Alternatively or additionally, the fibrous suspension used in forming the cakes or filters/skirts may be manipulated mechanically (e.g., vibrationally), chemically (e.g., via inclusion of dispersants or other Theological agents in the suspension), magnetically, and/or electrostatically. Such manipulation can be used to achieve a random/isometric or an oriented distribution of the fibers and or particulates, as desired.

An advantage stemming from the ability to manipulate fiber orientation is that a multi-layer component can be developed (by application of different fibers in different liquid suspensions) in which fibers are oriented in each layer so as to promote drainage therethrough and/or to achieve a desired set of product characteristics.

Secondary aspects of the cake/casing produced can be altered based upon the characteristics (e.g., shape, surface features) of the skirt/filter being used. This is important in that it can be easier and less expensive to produce a specially modified skirt than to do so with the main tooling, especially if it would dictate the need to frequently change and/or replace the main tooling.

Another advantage of the present invention, associated with the casting or molding of a given part, is that the molding tool may be used to carry the cast portion through multiple process stages/steps after the initial casting, so as to thereby reduce the chances of the failure of such a cast or molded part during such subsequent processing steps, especially if the part in question is a thin, molded component.

Yet another advantage of the present invention is that a wide range of composite/homogeneous structures can be formed of any of, for example, various sizes, shapes, and/or compositions.

An even further advantage of the present invention is that the molding/casting system of the present invention can be applied to processes such as paper making or polymer-bound matrix-composite formation, each of which essentially yield a finished product upon removal from the molding tool of the present invention, or to such processes as the near-net-shape production of green-state bodies which require a further firing or sintering step.

An additional advantage of the present invention is that the casting/molding process allows for the near-net-shape manufacturing of potentially complex components without further machining. For example, via the process of the present invention, it is possible to produce a two-inch diameter hemisphere composed of a lead zicronate titanate (PZT) material (i.e., a common piezoelectric material) so as to meet a tolerance requirement of 10/10,000 inch, without any need for further machining.

Yet an additional advantage of the present invention is that the process is flexible enough to permit the deposition of a mold or cast material around a reinforcement matrix material (e.g., carbon or Kevlar gauze), or first about or on a wood or paper matrix material.

Further, an additional advantage of the process may be to create a high order permeable structure, useful for electrodes and other uses in fuel cells.

### BRIEF DESCRIPTION OF THE DRAWINGS

The features and advantages of this invention, and the manner of attaining them, will become more apparent and the invention will be better understood by reference to the following descriptions of the embodiments of the invention taken in conjunction with the accompanying drawings, wherein:

FIG. 1 is an exploded, partially schematic, cut-away view of the molding/casting arrangement of the present invention;

FIG. 2 is a perspective, partially cut-away view of the mold plate shown in FIG. 1;

FIGS. 3-5 are exploded views of alternate embodiments of the casting/molding system for producing various size and shape preforms;

FIG. 6 is a flow chart illustrating the steps of a method of the present invention for molding a castable material; and

FIG. 7 is a cut-away, side view of an alternate embodiment of a casting system using a skirt to produce variances in the preform.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF THE INVENTION

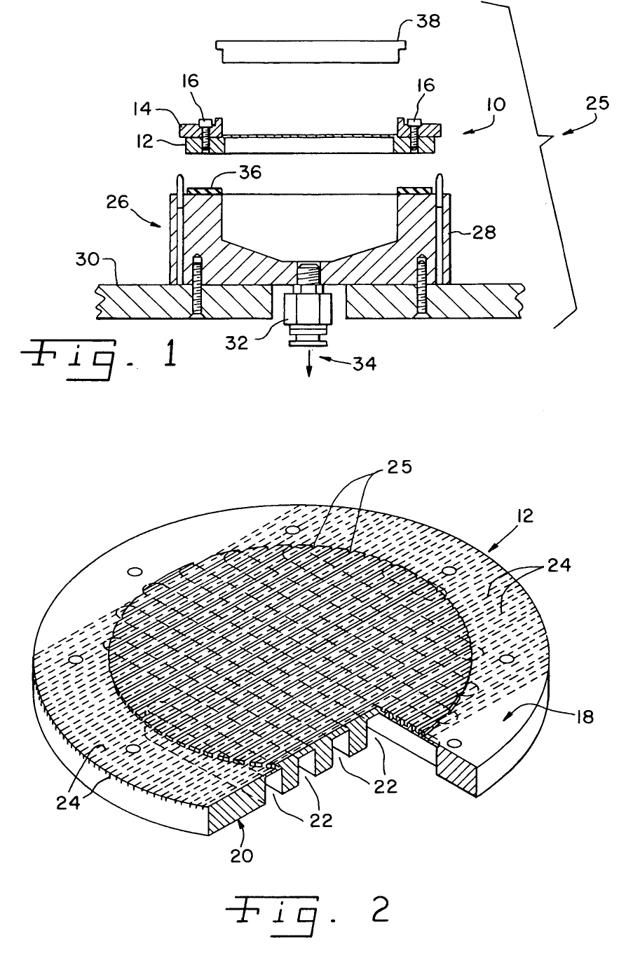

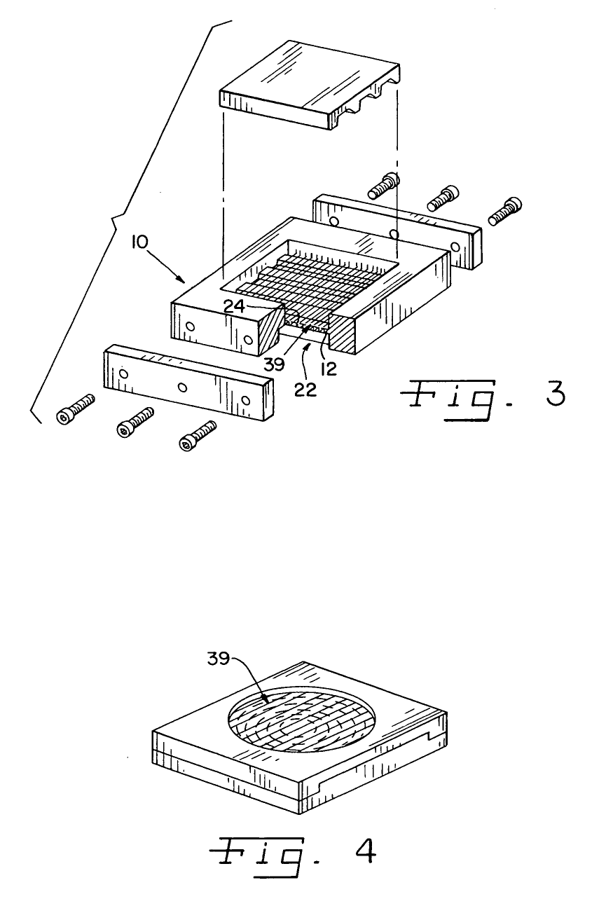

Molding tool 10 of the present invention is illustrated in FIGS. 1 and 2. Molding tool includes a mold plate 12 and a clamp ring 14 fastened together via screw 16.

Molding tool components 12, 14, and 16 are advantageously made from a material that can withstand up to 1400° F. without scaling or deforming in any manner. Some potential materials for these components are 316, 321, or 347 stainless steel; titanium; a ceramic material; and/or a high-temperature composite (e.g., ceramic/ceramic or ceramic/metal). Such a material is chosen as the tooling 10 needs to withstand temperatures as high as 1400° F. is so that tool 10 may be fired at a relatively high temperature for the purpose of cleaning therefrom any fibrous, particulate, or binder material which may become lodged therein (especially in plate 12). After reducing such clogging/fouling waste to an ash, to the degree possible, the tool is then high-pressure washed and made ready for reuse.

Mold plate 12 includes a mold surface 18 and a back surface 20. Mold surface 18, in the embodiment of FIG. 2, is machined to form the shape 23 of the product to be formed therewith. Upon forming mold surface 18, back surface 20 has channels 22 machined therein to within a few thousandths of an inch of the contoured/shaped mold surface 18. Such channels 22 generally extend so as to correspond to or slightly exceed the portion of mold surface 18 being used to define the shape of the product to be made therewith. Further, channels 22 are advantageously co-parallel to promote efficient fluid flow from back surface 20.

Vent/drain slots 24 are provided in mold surface 18 for the purpose of venting steam and/or draining a molding or casting suspension. Slots 24 are formed in a final machining step with respect to the formation of mold plate 12. This process is accomplished, advantageously, by using EDM wire cutting technology to make cuts perpendicular to the face of the tool plate 12 and orthogonal to channels 22 in back surface 20. These cuts 24 are made just deep enough to connect to a potential opposing channel 22 in back surface 20 of a mold plate 12.

Like channels 22, slots 24 may be arranged co-parallel or nearly so to each other to promote uniform fluid flow through mold face 18. Yet it may prove advantageous to arrange slots 24 in any of a variety of patterns, for example: a star-shape, a series of concentric circles, a spiral-shape, a series of nested polygons, or potentially a non-regular pattern. Any of these or other patterns may be chosen to achieve a desired fluid flow for mold base 18. While in most instances a uniform fluid flow will be desired, there may be instances in which a controlled non-uniformed fluid flow is desired to thereby specifically create variances in the surface of the cake being formed thereupon. No matter the pattern, it is generally preferable that slots 24 be made as narrow as possible yet still able to sufficiently vent steam and/or drain the fluid (i.e., liquid or gas) portion of the molding or casting suspension therethrough. For example, slots 24 should have a width on the order of 0.4 mm or less.

An advantage of using narrow slots 24 over round holes, as used in prior art drying apparatuses, is gained through the surface area of the vents. The very narrow slots 24 move more steam/fluid in a shorter time and do not promote deformation and/or dimpling lo of the final part (as may be the case with round holes). Such advantages also extend over prior art apparatuses that employ slots that are wider and/or employ rounded slot ends. Specifically, the narrow slots 24 in combination with the much wider channels 22 (on the order of 6-9 mm) can actually together produce a venturi effect when back surface 20 is subjected to a vacuum or negative pressure. This venturi effect tends to promote the flow is of fluid away from surface 18 and out of the part formed thereupon.

Additionally, the arrangement of channels 22 to slots 24 helps to promote a uniformity in the venting and/or draining processes, given that each channel 22 is associated with multiple slots 24. Thus, if a vacuum should be more effectively pulled through one slot 24 than another or if one of two adjacent slots 24 should become clogged, the effect thereof on the product formed on mold surface 18 would not be as nearly pronounced as if there were solely a one to one correspondence between a given channel 22 and a slot 24.

Prior to being used, tool 10 advantageously is subjected to a polishing step. One such method of polishing is to blast tool 10 with polishing beads to demur and polish the face 18 and back 20 of mold plate 12. It is, however, to be understood that other methods of polishing and deburring could prove appropriate and are considered within the scope of the present invention.

Molding tool 10 is advantageously used as part of a molding arrangement 25 which further incorporates a vacuum device 26. Vacuum device 26, as illustrated in FIG. 1, includes a vacuum mold base 28, a vacuum table 30, a vacuum connection 32, and a vacuum source 34 (shown schematically), and a seal member 36.

The structure of vacuum base 28 is such that it promotes a uniform distribution of a vacuum relative to back surface 20 once mold plate 12 is in place against seal member 36. Seal member 36 helps to maximize the amount of vacuum that is delivered to channel 22 and also helps minimize any wear of back surface 20 and/or vacuum mold or base 28. Additionally, it is advantageous for vacuum source 34 to be adjustable so that various molding/casting parameters can be accommodated (e.g., molding weight/density, molding complexity, durability of cake formed, and/or general ease with which a particular fluid can be drawn through channels 22 (i.e., steam is easier to move than a liquid suspension material)).

A cure plate 38 may also be incorporated into molding arrangement 25. Such a cure plate 38 may advantageously be configured to provide thermal energy (i.e., act as a heating element) needed as part of a curing step. Additionally or alternatively, cure plate 38 may function to place a finished surface on a newly cast part; supply an embossed shaped; act as press element to influence overall part shape and/or density;

and/or control the final thickness requirements. Besides potentially acting as an aid to curing, cure plate 38 can be heated so as to convert water (or other carrier fluid) associated with a fibrous and/or particulate suspension into steam (or gas) to facilitate the removal of such a fluid through slots 24. It is to be understood that cure plate 38 may take any of various forms, in order to facilitate the production of a desired product shape.

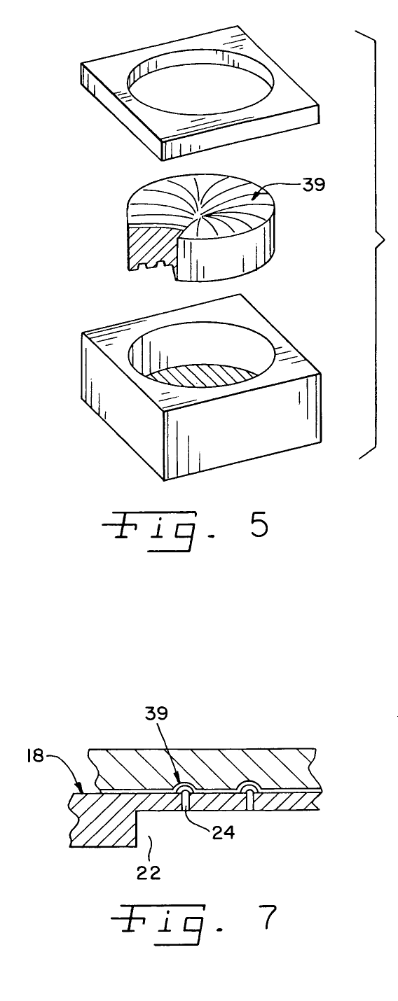

The embodiments of molding arrangement 25 shown in FIGS. 3-5 illustrate the variety of complex shapes which may be formed using the process of the invention. As can be seen from FIGS. 3 and 4, mold arrangement 25 can be developed for casting thicker, shaped pieces or molding thin fragile parts. While FIG. 5 illustrates a system 25 designed for forming a cone or funnel shape, it is well within the scope of the present invention to create a molding arrangement for forming cylinders, domes, or other complex shapes, including, as seen from FIG. 3, parts with raised portions and/or valleys/grooves. As a result, it is possible to use molding arrangements 25 to create any of a variety of components including, but not limited to electrodes, fuel cell components, piezoelectric components, audio speakers, aerospace components such as nose cones, and semiconductor components (including multi-layer devices).

The highly advantageous component of molding arrangement 25 (as indicated, for example, in FIGS. 3-5) is molding/casting skirt or filter 39. Skirt or filter 39 allows for optimum operation of molding arrangement 25 by acting to catch particles and/or fibers which may otherwise be able to pass through a slot 24 within mold surface 18. Such a skirt 39 can be engineered to be able to trap or capture particles or fibers on the order of a micron or larger. Skirt 39 ideally is formed of a fibrous material (woven and/or non-woven) in which the fibers forming the skirts are chosen so as to be a sufficient size and geometry to catch the fibers and/or particles being cast or molded thereupon. In addition to being configured so as to be able to cause the deposition of potentially micron-sized material thereupon, skirt 39 must still promote the easy flow of suspension fluid therethrough during the vacuum forming process. Due to the presence of skirt 39, the size of slots 24 in mold surface 18 does not necessarily act as a limiting factor in the size of particles and/or fibers which may be cast using molding arrangement 25. Instead, as fine of material as desired can be cast and/or molded, as long as such a material can be captured by a given skirt 39.

Various other options are available with the use of skirt 39. It may prove desirable to make skirt 39 a part of the permanent structure of the preformed being created, potentially to act as a surface strengthening component and/or to produce a desired surface characteristic, for example. On the other hand, skirt 39 need not be incorporated as part of the final cast/mold structure. The surface chemistry and/or geometry of skirt 39 may actually be optimized to promote a release thereof from a preform. While the examples only show one skirt 39 being used, it may be desired to employ a skirt on both the top and bottom of a part being formed to act as a wrapper around the preform to thereby e.g., promote easy release from mold arrangement 25 and/or allow the part to be more readily handled. Yet another potential advantage of skirt 39 is that it has the potential to be employed with a molding arrangement which employs a simple screen instead of mold plate 12 to allow deposition of the molding material while allowing passage of the suspension fluid via the vacuum created by vacuum source 34.

Molding tool 10 and, more generally, molding arrangement 25 have at least two general processes in which they can be advantageously employed. The first type of process is a pulp molding process in which arrangement 25 is used for example in a standard die-dried (pulp molding) process. The second process is a method of molding or casting a form from a suspension including a chosen material to be formed (FIG. 3). While both molding and casting are used to create a part that is a “negative” of a given mold shape, the term casting is generally used when a thicker suspension is being employed and, generally, a bulkier/thicker component is desired to be produced. The suspension for casting is generally composed of about 10%-35% solids (i.e., particulate and/or fibrous) as well as, any binders and/or additives. On the other hand, molding is the term used when a rather dilute suspension is used with the solid content advantageously being about 3% or less and preferably, on the order of 0.3%-0.10% solid. Most preferably, the solid content of the suspension is very low. Molding may promote a more even material distribution than is possible with casting and has proven very useful in creating components having very thin sections.

Molding arrangement 25 can, more particularly, be used with respect to two procedures associated with pulp molding. The first procedure is the felting of a paper/pulp blank where molding tool 10 is covered with a suspension made up of wood pulp, a synthetic blend of fibers, and/or other types of fibers along with water and/or another suspension fluid (e.g., another liquid or, potentially, a gas). It is also to be understood that such a suspension may also include, for example, chemicals (such as dispersants) which contribute to the suspension chemistry and/or ingredients such as binders which aid characteristics of the formed felt/blank.

Upon covering molding tool 10 with the desired suspension, a vacuum is applied to molding tool 10 via vacuum device 26 in order to draw the water and/or other carrying medium from the suspension, thereby resulting in the formation of a felt-like preform on mold surface 18. Molding tool 10 is then removed from the suspension, and the remaining water/suspension medium is pulled from the felted blank via the vacuum to thereby produce a preform of a preset dryness.

The second procedure associated with pulp molding which may incorporate molding arrangement 25 and/or molding tool 10 is the drying and pressing of the felted blank to the final shape and dryness thereof. This procedure is accomplished by placing the damp felted blank or preform into a molding arrangement 25 in which the molding tool 10 is heated. Such heating of the mold 10 may be accomplished by placing molding tool 10 in a heated environment such as an oven or by bringing a heated cure plate 38 into contact with the blank or preform. If heated cure plate 38 is used, it can provide an element of pressure to promote drying and/or forming. The steam that is generated upon heating molding tool 10 is able to be vented through the combination of slots 24 and channels 22 in mold plate 12. To further aid in the venting of steam, a woven or non-woven screen material (not shown) may be provided over slotted mold surface 18.

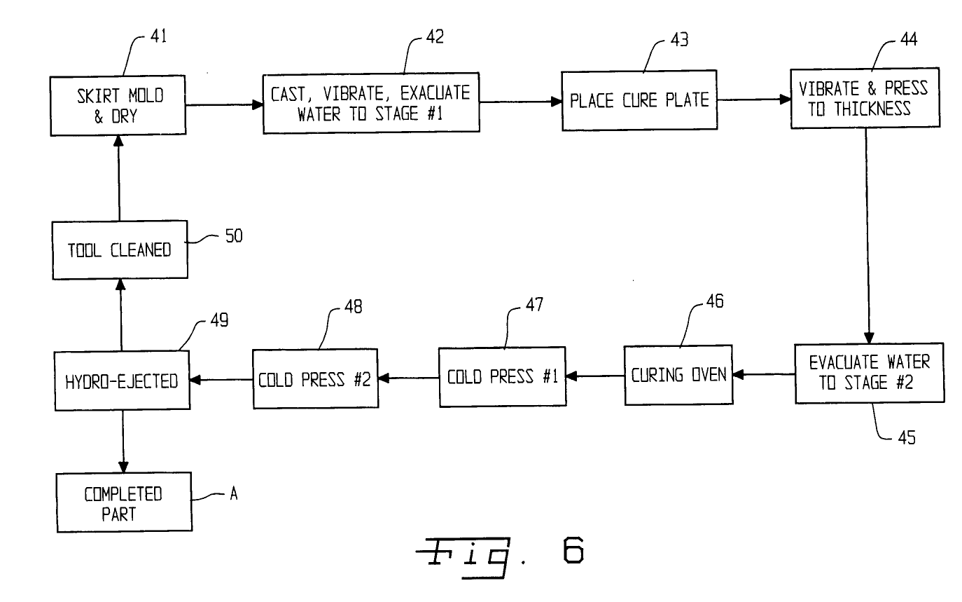

FIG. 6 is a flow process chart outlining ten potential steps 41-50 associated with the second general process in which molding arrangement 25 may be incorporated. The first step 41 is to mold and dry skirt or filter membrane 39 for use with the casting/molding process. The skirt membrane 39 used in step 41 is created from a suspension of specially formulated fibers that are manipulated in the molding operation thereof to form a tight, strong filter membrane that may or may not become part of the final product. This membrane can be formed on any standard woven or non-woven molding screen and/or on the slotted tool 10 associated with molding arrangement 25.

The suspension formulation used to achieve the desired filter membrane is chosen so as to get the desired suspension chemistry and rheology needed to achieve a substantially uniform distribution of the fibers both in suspension and upon precipitation thereof in such a manner so as to produce an acceptable preform in a timely fashion. Such factors as fiber material, size, and size distribution; base suspension composition and viscosity; mold shape and configuration; and vacuum characteristics can affect the generation of the filter membrane. Depending both upon the suspension characteristics and final filter membrane characteristics desired, fibers may be chosen that are anywhere in the range of microns to centimeters in length, as required. The same general limitations will extend on to the casting or molding material suspension with the understanding that the casting or molding material may include particulate matter, instead of or in combination with fibers, with the particle size and size distribution also being a factor for consideration under such circumstances.

Upon forming and drying of the skirt 39 as per step 41, a premixed casting material is poured on, as per step 42, onto the skirt membrane formed in step 41. As part of step 42, a leveling operation is done either by vibration cycles and/or a mechanical operation. In further conjunction with step 42, a vacuum (i.e., via vacuum source 34) is applied to back surface 20 of mold plate 12, carrying the skirt and cast part on mold surface 18. This vacuum may be constant or cycling in nature. A cycling vacuum can be used to create a pulse wave to drive the liquid materials down through the denser material associated with the skirt and/or cast part. Such a pulse wave thereby creates paths that open and then close, thereby preventing a constant channel from being formed within either of the skirt or cast part that would later potentially cause the part to have stress cracks formed therein.

After most of the liquid is pulled from the part via step 42 and a firm cake has been formed as the cast part, two potential routes may be taken. One route may be to remove the cake from the mold tool using standard die-dried operations, the cake then being pressed to shape. The other avenue which may be taken is that the tool, with the formed cake therein, may be moved to another operation such as an embossing, pre-dry/pre-cure, or shaping operation, or a combination thereof. In the case of the first option, the processing of the cast cake part that is done in conjunction with molding arrangement 25 would be complete. This first option works very well, for example, with a product that has enough mass to it to form a cake (e.g., FIG. 3) that can be transferred to a pressing operation. However, if the part is very thin and/or has fine details associated with it (e.g., FIG. 4), such as fuel cell plates, or has fragile ribs, such as fuel cell dryer plates, then the first process would not be an optimal choice. In the latter process option, the cake is maintained with molding arrangement 25 for at least another operation.

In pursuing the second route beyond step 42, the next step is to place cure plate 38 upon the soft casting created from step 42. In this instance, cure plate 38 may or may not be heated since a separate heating step (step 46) is separately provided for. (If cure plate 38 is heated, the provision of a cure oven to effectively perform step 46 may be obviated.) Cure plate 38 does, however, function to at least one of put a finish surface on the newly cast part and/or to control the final thickness requirements therefor. If used to finish the surface, cure plate 38 may provide an embossing or simply give the final part a proper finish. Cure plate 38 is then used in the next step 44 to vibrate and/or press the part to its final finished thickness.

In step 45, a high vacuum is applied to back surface 20 of mold plate 12 via vacuum device 26, and all the liquid or fluid that can be removed via vacuum is done so here. Molding arrangement 25 and the casting carried thereby are then moved through a curing oven, as per step 46, that brings the tool and part up to a preset temperature. This preset temperature may be chosen so as to promote further drying and/or to initiate the curing of any binder materials within the casting. It is to be understood that the general process may be set up such that the entire molding arrangement 25 is set up to move through each of the steps shown in FIG. 3, including traveling through the curing oven 46, or such that molding tool 10 along with the cast/molded part are actually moved, with each vacuum device 26 in use remaining in a fixed station location.

Molding tool 10 and the cast part carried thereby (and potentially all of molding arrangement 25) are then transported into a non-heated press, as indicated by step 47, where the part is pressed between molding tool 10 and cure plate 38. This pressing operation also starts the cooling down of the tool 10 and its accompanying part. From step 47, the tool and part are conveyed to a second cold press in which the step set forth in step 47 is essentially repeated.

In step 49, the cast part is freed from molding arrangement 25. First, cure plate 38 is removed from molding tool 10 and the cast part. Molding tool 10 is then inserted into a special fixture (not shown) that seals off back surface 20. A hand with suction cups (not shown) is attached so as to move into place over the cast part and then a high pressure/low flow of water causes a hydraulic force that applies even forces on the cast part to remove it from the tool 10 and concurrently clean the slots 24 of the tool. The completed part A is then transferred via the suction-cup hand to a final process or inspection area.

The molding tool 10 and/or molding arrangement 25 is then subject to a post-processing cleaning step 50. In this step 50, water jets may be used. However, if the tool is fouled or clogged so that it cannot be sufficiently cleaned using water jets alone, it advantageously will be heated up to 1400° F. (a lower heating temperature may be, of course, used if that is all that is necessary to effectively clean tool 10) and then finally cleaned using water jets so that it can then be reused. It is to be understood that other cleaning means such as brushes or cleaning fluids may be used, alternatively or additionally.

A further enhancement of the invention is available by making use of the slot design 24 (FIG. 7) in the mold plate 12 in conjunction with a specially designed skirt 39. A shape 23 (not specifically shown) could be lasered into the tool face 18 connecting the slotted pattern 24 to the feeder channels 22 at back surface 20 of plate 12. Then, using the specially formed skirt 39, bulk material could be deposited/cast onto skirt 39, forming a ridge or mound (typically less dense than the surrounding body) over the area of each slot 24. This forming of a ridge pattern would be very helpful in forming parts like fuel cell plates that require channels to be formed into the cast part. In such instances, when the part is pressed under heat, the bulky areas of the skirt may advantageously give way to an embossing tool (i.e., cure plate 38).

As an extension of this embodiment, skirt 39 may be shaped/formed to form shape detail and/or surface features in the part produced, in addition to, or opposed to, mold plate 12 since shaped skirt 39 should be more inexpensive/easier to produce than various-shaped mold plates 12.

The materials chosen for the skirt (step 41) and for cast/molded part A will generally be dictated by the product requirements as well as the suspension chemistry (as outlined previously). In addition to the fibrous materials composing the bulk of the skirt material, special binders, mold releases, colorants, and/or fillers may be employed therein. One or more of such additives could potentially also be used with the casting/molding material, depending on the application.

As for the casting material, a wide variety of material compositions and material forms may be employed. The material forms can range from fine grain castable materials in particulate form to fibrous materials, as well as combinations thereof. If an essentially homogenous casting/molding is desired, a powdered/particulate form of any one of a polymer, metal, or ceramic material may be employed. However, if a composite structure is desired, a combination of particulates and/or fibers of various sizes and/or compositions may be chosen.

For example, a polymer, such as a heat-curable resin (e.g., phenolic resin), can be chosen as a matrix and/or binder system material and one or more fibrous or particulate materials composed of any one of, e.g., a glass, plastic, elastomer, carbon, silicon nitride, silicon carbide, another ceramic, or a metal can be chosen as the reinforcement material. (While a matrix and a binder can each serve to hold a composite together, a matrix material is generally considered to be substantially continuous in nature.) With such a composite, the matrix and/or binder polymer can be cured (at least about 400° F.), and the composite essentially formed into a final, workable product upon performing steps 45-48 (as per FIG. 3). Polymer-based composites tend to offer significant strength/toughness while yet providing good flexibility.

Alternatively, steps 41 and 42 or steps 41-49 of FIG. 3 can be used to create a green-state near-net shaped product. This green-state product would typically be a ceramic/ceramic, ceramic/glass, metal/ceramic, or powdered metal or ceramic, advantageously held together by a temporary binder. As a green-state product, the product generally has enough strength to be handled but requires a further thermal processing step in order to achieve full strength and/or other (e.g., thermal, electrical, optical) capabilities. The use of curing oven 46 used in relation to step 46 may be useful in improving the intermediate strength of the green-state product if a heat-curable resin is used as a temporary binder material in the product. In any event, the completed part A, if it is a green-state near-net shaped product upon completion of step 48, will then need to be fired/sintered to produce the final usable product.

The casting/molding material can actually be chosen such that the material is initially a composite but such that the end product A is instead be a porous yet homogenous structure. A method by which such a structure can be achieved is to start with a composite casting material of a polymer fiber/polymer matrix combination. In such an instance, the polymer fiber is chosen such that it (but not the matrix material) will melt or burn out upon curing of the polymer matrix material. As such, only the polymer matrix material will be left and pores will be left in the structure where the polymer fiber had existed.

It has been found that the apparatus and process of the present invention is especially useful with respect to the casting/molding to shape of very fine carbon/carbon composites. In some instances, such carbon composites may use a temporary binder system and be sintered (heated) to their final state. In others, a resin binder/matrix may be employed that is cross-linked to produce a flexible final composite part.

It is to be understood that various shapes and sizes of completed mold/cast parts A can be achieved using various size and shape combinations for mold plate 12 and cure plate 38 and still remain within the scope of the present invention.

While not specifically shown in any of the figures, it is to be understood that multi-layer castings or moldings can be produced using the present invention to thereby achieve the desired characteristics. In such layers, the orientation, composition, and/or particle/fiber size distribution, by way of example only, can be varied for each of the layers. A potential use for multi-layer structures is in the area of semiconductor manufacture. For example, a semiconductor component produced in such a fashion could potentially have consecutive layers of carbon, a semiconductor material, silver, carbon, etc.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A molding plate for use in a molding tool for forming a part, said molding plate comprising:
a mold surface having a shaped portion corresponding to a desired shape for the part to be formed therewith, said mold surface having a plurality of slots therein, said slots extending substantially co-parallel and across said shaped portion of said mold surface, said slots having a corresponding slot width; and
a back surface opposite said mold surface, said back surface having a plurality of channels formed therein, said channels being formed deep enough in said molding plate so as to fluidly interconnect with at least a set of said slots, said channels being substantially co-parallel, said channels each having a channel width, said channel width being much greater than said slot width.

2. The molding plate of claim 1, wherein said channels are substantially orthogonal to said slots, said slots further being substantially perpendicular to said mold surface.

3. The molding plate of claim 1, wherein said back surface of said molding plate is configured for being operatively mounted to a vacuum device, the vacuum device thereby being able to deliver a vacuum to said mold surface via a combination of said slots and said channels.

4. The molding plate of claim 1, wherein said molding surface is capable of being used to form one of a pulp blank and a cast part.

5. The molding plate of claim 4, wherein the cast part is one of an essentially homogeneous structure and a composite.

6. The molding plate of claim 5, wherein the cast part is a composite, the composite including a matrix material and at least one of a fibrous material and a particulate material.

7. The molding plate of claim 5, wherein the cast part is a composite, the composite being composed of at least two components, each of the components being one of a polymer, ceramic, and metal.

8. A vacuum molding device for forming a preform, comprising:
a vacuum device;
a screen device carried by said vacuum device; said screen device being shaped so as to influence a final shape of the preform; and
a fibrous skirt positioned on said shaped screen device, said fibrous skirt being configured to filter thereupon, at least one of a particulate material and a fibrous material from a suspension to thereby facilitate creation of the preform.

9. A molding process for forming a fibrous or particulate structure, comprising:
providing a liquid having at least one of fibers or particulates in suspension; then
passing the suspension through a tool such that said fibers or particulates collect thereon to form the structure.

10. The molding process of claim 9 in which said passing step utilizes vacuum to pass the suspension liquid through the tool.

11. The molding process of claim 9 in which said passing step comprises pressurizing the suspension liquid to pass it through the tool.

12. The molding process of claim 9 further includes the step of providing a filter adjacent the tool, such that said suspension passes through said filter first before passing through said tool.
